(19) United States
(12) Patent Application Publication
(10) Pub. No.: US 2022/0014044 A1
(43) Pub. Date: Jan. 13, 2022

(54) ANTENNA FOR WIRELESS CHARGING SYSTEM

(71) Applicant: HUMAVOX LTD, Raanana (IL)

(72) Inventor: Asaf Manova-Elssibony, Tel-Aviv (IL)

(21) Appl. No.: 17/295,438

(22) PCT Filed: Nov. 22, 2019
(86) PCT No.: PCT/IL2019/051279

§ 371 Date: May 20, 2021

Related U.S. Application Data
(60) Provisional application No. 62/770,762, filed on Nov. 22, 2018.
(60) Provisional application No. 62/788,761, filed on Jan. 4, 2019.
(60) Provisional application No. 62/788,731, filed on Jan. 4, 2019.
(60) Provisional application No. 62/788,717, filed on Jan. 4, 2019.
(60) Provisional application No. 62/788,705, filed on Jan. 4, 2019.
(60) Provisional application No. 62/788,282, filed on Jan. 4, 2019.
(60) Provisional application No. 62/788,236, filed on Jan. 4, 2019.
(60) Provisional application No. 62/788,728, filed on Jan. 4, 2019.
(60) Provisional application No. 62/788,889, filed on Jan. 6, 2019.
(60) Provisional application No. 62/809,215, filed on Feb. 22, 2019.

(51) Int. Cl. H02J 50/20; H01Q 9/14; H01Q 7/00; H04B 5/00; H01Q 1/48; H01Q 1/36; H02J 50/12; H02J 7/00; H02J 50/40

(52) U.S. Cl. CPC H02J 50/20; H01Q 9/14; H01Q 7/00; H04B 5/0081; B64F 1/362; H01Q 1/362; H02J 50/12; H02J 7/0044; H02J 50/40; H01Q 1/48

(57) ABSTRACT

This invention is directed to antenna for wireless charging systems configured and operable to create strong electromagnetic near fields in a designated volume and by that to improve the coupling between a transmitting antenna and a receiving antenna of a wireless charging system, which improves the efficiency level of the electromagnetic energy transfer between said transmitting and receiving antennas of a wireless charging system, the antenna comprising a conductive material shaped to form two or more revolutions, each revolution adjacent to the previous revolution, wherein each of said revolution having a geometric shape. The antenna is further comprising a ground plane, wherein said formed conductive material is adapted to confine the electromagnetic near field distribution into a charging zone relative to the ground plane.

### CROSS-REFERENCE TO RELATED APPLICATION

The present PCT application claims priority to U.S. Provisional Application No. 62/770,762 filed Nov. 22, 2018 entitled “Wireless Charging Device”, U.S. Provisional Application No. 62/788,889 filed Jan. 6, 2019, U.S. Provisional Application No. 62/788,236 filed Jan. 4, 2019 entitled “Antenna for Wireless Charging System”, U.S. Provisional Application No. 62/788,282 filed Jan. 4, 2019 entitled “Charging Hooks For Wireless Charging”, U.S. Provisional Application No. 62/788,705 filed Jan. 4, 2019 entitled “Cup Holder For Wireless Charging”, U.S. Provisional Application No. 62/788,717 filed Jan. 4, 2019 entitled “Toolbox For Wireless Charging”, U.S. Provisional Application No. 62/788,728 filed Jan. 4, 2019 entitled “Head Phone Case For Wireless Charging”, U.S. Provisional Application No. 62/788,731 filed Jan. 4, 2019 entitled “Mobile Device Case For Wireless Charging”, U.S. Provisional Application No. 62/788,761 filed Jan. 4, 2019 entitled “Drone Charging System”, U.S. Provisional Application No. 62/809,215 filed Feb. 22, 2019 entitled “A Wireless Stand Charger”, the filing date and full disclosures of which is incorporated herein by reference in their entirety.

### FIELD OF THE INVENTION

The present invention is in the field of wireless charging in general, and antennas for RF coupling between a transmitting unit and a receiving unit in wireless charging systems in particular. This invention is further related to a novel wireless charging system, in which one antenna is responsible for determining the distribution of the field created and the distribution of the waves around, within, or on top of the charging device.

### BACKGROUND

Use of receiving and transmitting antennas for electromagnetic energy transmission in well known in the art. However, the efficiency of the process is usually low and a lot of energy is wasted. In addition, the coupling process, by itself, is pretty much a strict process and the coupling between the transmitting and the receiving antennas is sensitive and unstable and may change by changes in the positioning of the transmitting and the receiving units of the wireless charging system and the design of the transmitting and the receiving antennas. Furthermore, the coupling process may be further affected by the presence of other components in the surroundings, and environmental conditions. These factors result in low efficient energy transfer between the transmitting and the receiving units. Accordingly, there remains an unmet need for a receiving and transmitting antennas for electromagnetic energy transmission systems which promote coupling and energy efficiency between a transmitting unit and a receiving unit of a wireless charging system.

### SUMMARY OF INVENTION

The present invention is aimed to provide in one aspect, a novel antenna configured and operable to improve and simplify the coupling process between the transmitting unit and the receiving unit and raise the efficiency level of the RF energy transfer between the transmitting and the receiving units of wireless charging system. The novel antenna is one that has in some embodiments, a plurality of loops in the antennas design. The novel antenna with the plurality of loops can have a circular shape, oval shape, rectangular shape, square shape or else. The antenna can be flat, with two dimensions or have a certain height (three dimensions), it can have a uniform diameter/perimeter or variable diameter (as in flat spiral structure), and it can be referenced to a ground plane in a vertical or horizontal manner, whereas, the ground position and the inner parameters of the antenna all effect the direction, orientation, intensity and distribution pattern of the electromagnetic/electric field created an consequently the charging zone. The novel antenna can be a transmitting antenna or a receiving antenna and thanks to its unique structure it “takes control” on the field created while the “other antenna” matches itself to the conditions created. The other antenna also denoted hereinafter: the “coupling antenna” can be a conductive wire, a strap of conductive material, another open looped antenna or any conductive particle that is an integral component (chassis) of a device under charge (denoted hereinafter: “DUC”), or the charger (when the DUC comprises the multiple loops antenna. Thus, the novel antenna may be used either as a transmitting antenna or as a receiving antenna for wireless charging. The term “open loop antenna” as used herein is aimed to describe an antenna for wireless charging having two open ends and multiple wrapping/looping/turnings of a conductive wire. The terms: “loop antenna”, multiple loops antenna”, “open looped antenna”, “coiled antenna”, “spiral antenna”, “first antenna”, and “none-radiative antenna” are all meaning the same and may be used interchangeably hereinafter in a single or plural form.

The term “charging zone” as used herein refers to a volume/space inside, around or on top of a housing in which the charging process is to occur and in which a device to be charged is to be located. The transfer of the electromagnetic energy from an emitter arrangement (transmitting unit and transmitting antenna) located in the housing to a receiving arrangement (rectifier and receiving antenna) located in a DUC is performed at a maximal energy volume (denoted hereinafter: “MEV”), that is a volume in which the electromagnetic energy is of substantially maximal intensity, that is created within the charging zone upon coupling between the transmitting antenna and the receiving antenna.

In a further aspect, the present invention is aimed to provide novel wireless charging devices and wireless charging systems based on the novel antenna concept presented herein.

In one example, a wireless charging device in which the transmitting antenna is responsible not only for transmitting RF waves but further for determining the distribution of the transmitted waves within the charging device and the creation of a charging zone is provided. For reference, in other RF wireless charging devices previously described in the art, including the wireless charging devices provided in WO2013/179284 and WO2015/022690, incorporated herein by reference of the same inventor, a conductive structure is required in order to have an efficient RF based wireless charging device. In contrast, the transmitting antenna of the present invention functionally serves as an antenna and as a conductive structure and has a major role in distribution of the RF waves around, within, below or on top of the area defined by the transmitting antenna and the creation of a charging zone and a MEV within it. This ability allows the coverage of the charging device to be made from various materials and not necessarily from a conductive material.

In one aspect, the invention is directed to an antenna configured and operable to create strong electromagnetic near fields in a designated volume and by that to improve the coupling between a transmitting antenna and a receiving antenna of a wireless charging system, which improves the efficiency level of the electromagnetic energy transfer between said transmitting and receiving antennas of a wireless charging system, the antenna comprising a conductive material shaped to form two or more revolutions, each revolution adjacent to the previous revolution, wherein each of said revolution having a geometric shape.

The antenna may further comprise a ground plane, wherein said formed conductive material is adapted to confine the electromagnetic near field distribution into a charging zone relative to the ground plane. in some embodiments, the conductive material is configured such that the strong electromagnetic near field distribution covers any direction and orientation inside the designated volume for the resonated frequencies.

Thanks to the unique structure of the antenna of the invention as described in detail hereinbelow and with reference to the figures, the resonant frequency of the electromagnetic energy transfer between the transmitting and receiving antennas of a wireless charging system may be adjusted by altering the number of revolutions of the conductive material, altering the size of the revolution, altering the distance between revolutions, altering the thickness of the conductive material, and combinations thereof.

The charging aperture of the antenna is determined by the geometrical shape of the conductive material and the relative position and/or orientation of the conductive material to the ground plane. In more detail, the charging aperture is the surface area of the volume in which the near field energy is focused (the charging zone).

In some embodiments, the revolutions of the conductive material of the antenna may be mounted on or near a ground plane and oriented to distribute the electromagnetic near field in the inner volume of the two or more conductive material revolutions and the ground plane to create a charging zone interior to the conductive material revolutions for charging a rechargeable device. In this scenario, the charging aperture of the structure is the revolution perimeter.

In some further embodiments, the revolutions of the conductive material may be mounted in a distance away from the ground plane, or oriented relative to the ground plane, to distribute the electromagnetic near filed in the perimetric volume around the conductive material to create a charging zone on the perimeter of the conductive material revolutions for charging a rechargeable device. In such scenario, the charging aperture of the structure is the perimetric surface area of the revolutions.

In some further embodiments, each revolution of conductive material is outward of the previous revolution to form a flat conductive material revolutions and mounted above a ground plane to distribute the electromagnetic near field in the volume above the conductive material to create a charging zone on the surface of the conductive material revolutions for charging a rechargeable device. In such scenario, the charging aperture of the structure is the surface area of the revolution having the larger perimeter.

The dimensions of each revolution and the dimensions of the structure of conductive material in all embodiments mentioned above are significantly smaller than the resonated frequency wavelength.

The revolutions of conductive material can be formed to make any repeatable shape, any helical height or any perimeter.

In some embodiments, the revolutions of conductive material may be configured to be attached to a transmitting unit of a wireless charging system or to a receiving unit of a wireless charging system.

In further aspects, this invention is directed to a wireless charging system comprising: a transmitting unit; a receiving unit; and at least one antenna of any of one of the embodiments mentioned above. In such wireless charging system, the at least one antenna attached to the transmitting unit is different from the at least one antenna attached to the receiving unit, wherein the antennas are different in structure or geometric shape.

In some specific embodiments, the at least one antenna attached to the transmitting unit is an open loop antenna and at least one antenna is attached to the receiving unit is an open loop antenna having a different length, wherein the antenna that resonate in a lower frequency is the dominant antenna that determines the frequency.

The wireless charging system mentioned above may further comprise a second antenna (Rx) wherein the second antenna is significantly smaller then wavelength of the frequency resonated by the first antenna, wherein the near field generated by said first antenna resonates said second antenna in certain frequency thereby causing a strong coupling between the antennas.

In some embodiments, the second antenna may be made of any conductive material and can be in any shape and size regardless to the resonant frequency. Alternatively, the second antenna may be an off-the-shelf inductive charging coil.

In further aspects of the invention, a charging hook for wireless charging of at least one device under charge (DUC) is provided. The charging hook comprising at least one means for holding a DUC; at least one transmitting unit; and at least one antenna according to the description above; wherein the electromagnetic near filed created is distributed in the volume around the at least one means for holding a DUC.

In further aspects of the invention, a charging cup holder for wireless charging of DUC, the charging cup holder comprising: a housing defining a volume configured to hold one or more DUC's; at least one transmitting unit; at least one antenna of any of the antennas described above; wherein the electromagnetic near field distributed within the volume configured to hold DUC's.

In further aspects of the invention, a charging toolbox for wireless charging of at least one portable tool or battery is provided. The charging toolbox comprising: a housing having an internal volume; a top piece to be attached to the housing as a lid capable of being opened to allow the routine placement or removal of at least one portable tool or battery; at least one transmitting unit; at least one antenna of any of the antennas described above; and wherein the electromagnetic near field is distributed in the internal volume of the toolbox. In some optional embodiments, the at least one antenna is operable to emit the electromagnetic near field to provide a maximal intensity of electromagnetic near filed within at least a part of said charging zone.

In some optional embodiments, the at least one antenna of any of the antenna described above can also be the receiving antenna connected to a receiving unit, and not necessarily the transmitting antenna connected to the transmitting unit.

In further aspects of the invention a headphone charging case for wireless charging of at least one set of headphones is provided. Thee headphone charging case comprising: a housing configured to hold one or more headphones; at least one transmitting unit; and least one antenna of any of antennas of the invention described above; wherein the electromagnetic near field is distributed in the volume configured to hold one or more headphones.

In one further aspects of the invention, a mobile device charging case for wireless charging of at least one mobile device, the mobile device charging case comprising: at least one transmitting unit; and at least one antenna of any of the antennas described above; wherein the electromagnetic near field is distributed in the internal volume configured to hold one or more mobile devices.

Yet, in a further aspect of the invention, a case for use with a mobile device to enable the mobile device to receive a charge through wireless charging, the case comprising: a case body is configured to be secured around a mobile device, wherein said case body includes a front piece and a back piece configured to releasably attach to each other to enclose a mobile device; and a receiving unit, connected to at least one antenna of any of the antennas described above.

In a further aspect, a drone charging system for wireless charging of at least one drone device is provided. The drone charging system comprising: a housing act as a pad or docking station for the drone device; at least one transmitting unit; and at least one antenna of any of the antennas described above; wherein, the electromagnetic near field is distributed in the volume above the pad or docking station.

The present invention in one additional aspect is directed to a wireless rechargeable device comprising at least a receiving unit and at least one antenna of any of the antennas described above.

In some specific embodiments, the receiving antenna in the wireless rechargeable device may be made of any conductive material and can be in any shape and size regardless to the resonant frequency.

In some other specific embodiments, the receiving antenna in the wireless rechargeable device may be an off-the-shelf inductive charging coil.

In yet one further aspect, this invention is directed to novel antenna for wireless charging configured and operable to create strong electromagnetic near fields in a designated volume, said antenna is characterized by having a conductive material shaped to form two or more cyclic revolutions (loops) each revolution having a the same geometrical shape as the revolution adjacent to it, wherein said strong electromagnetic near field created resonates another antenna to be coupled thereto as a receiving antenna, to thereby improve the efficiency level of the electromagnetic energy transfer between the two antennas, and wherein the resonant frequency of the electromagnetic energy transfer between the two antennas of a wireless charging system may be adjusted by altering the number of revolutions of the conductive material, altering the perimeter of the revolution, altering the distance between two adjacent revolutions, altering the thickness of the conductive material, altering the total height of the antennas, and combinations thereof. The two or more cyclic revolutions may be arranged in three-dimensional (3D) or two-dimensional (2D) structure.

### BRIEF DESCRIPTION OF THE DRAWINGS

Examples illustrative of embodiments of the disclosure are described below with reference to figures attached hereto. In the figures, identical structures, elements or parts that appear in more than one figure are generally labeled with the same numeral in all the figures in which they appear. Dimensions of components and features shown in the figures are generally chosen for convenience and clarity of presentation and are not necessarily shown to scale. Many of the figures presented are in the form of schematic illustrations and, as such, certain elements may be drawn greatly simplified or not-to-scale, for illustrative clarity. The figures are not intended to be production drawings. The figures (Figs.) are listed below.

FIGS. 1A-1D are schematic illustrations of various optional examples of the novel open loop antenna of the invention, wherein, FIG. 1A illustrates at least one embodiment of the novel open loop antenna in a geometric shape of a circle; FIG. 1B illustrates at least one embodiment of the novel open loop antenna in a geometric shape of a triangle; FIG. 1C illustrates at least one embodiment of the novel open loop antenna in a geometric shape of a rectangle, and FIG. 1D illustrates at least one embodiment of the novel open loop antenna in a geometric shape of a flat, 2D spiral antenna.

FIGS. 2A-2C are schematic exemplifying illustrations of the near field distribution created by the novel open loop antenna illustrated in FIGS. 1A and 1D, showing the orientation of the field created upon referral of the antenna to a ground, wherein: FIG. 2A illustrates the circular antenna of FIG. 1A referred to a ground plane in a vertical position; FIG. 2B illustrates the circular antenna of FIG. 1A referred to a ground plane in an horizontal position; and FIG. 2C illustrates the flat spiral antenna of FIG. 1D referred to a ground plane in an horizontal position.

FIGS. 3A-3E illustrate at least some embodiments of a novel receiving antenna made, wherein FIG. 3A illustrates a receiving antenna shaped as a curved conductive strap; FIG. 3B illustrates a receiving antenna shaped as curved coiled wire; FIG. 3C illustrates a receiving antenna shaped as a conductive wire; FIG. 3D illustrates a conductive housing of a device under charge that is used in addition to its original functionality as a receiving antenna for wireless charging; FIG. 3E illustrates an off-the-shelf inductive coil that is being used in addition to its regular functionality as a receiving/transmitting antenna for the wireless charging system of the invention.

FIGS. 4A-4D are schematic illustrations of some optional wireless charging systems comprising open loop antennas as transmitting antennas coupling with different types of receiving antennas wherein, the open loop antenna is referred to the ground plane to create an inner electromagnetic field at the volume between the antenna and the ground plane.

FIGS. 4E-4F are illustrations of simulations results of the charging system illustrated in FIG. 4A.

FIGS. 5A-5C are schematic illustrations of one optional wireless charging system comprising a charging device with open loop antenna referred to the ground plane to create electromagnetic field that around the loop antenna, suitable for a charging device designed for example, as a charging stand, and headphones (DUC) to be hanged on the charging stand for wireless charging, wherein FIG. 5A is a schematic illustration of the charging system; FIG. 5B is a schematic illustration of the devise under charge; FIG. 5C is a schematic illustration of the charging device with the transmitting unit and the transmitting antenna.

FIG. 6 is a schematic illustration of one another optional wireless charging system according to the present invention, comprising a charging device with a flat spiral open loop antenna referred to the ground plate in a manner that the electromagnetic field created on top of the looped antenna. Such distribution of the electromagnetic field allows a design of a charging device as a charging plate, and a wireless rechargeable drone (DUC).

FIG. 7 is a schematic illustration of one another optional wireless charging system according to the present invention, comprising a charging toolbox, wherein the chassis of the box function as a transmitting antenna and power tools having open loop antennas that function as a receiving antenna for wireless charging.

It should be clear that the description of the embodiments and attached Figures set forth in this specification serves only for a better understanding of the invention, without limiting its scope. It should also be clear that a person skilled in the art, after reading the present specification could make adjustments or amendments to the attached Figures and above described embodiments that would still be covered by the present invention.

### DETAILED DESCRIPTION

Wireless charging systems and wireless charging devices are well known in the art. Some examples of such charging systems and devices that are using electromagnetic energy for charging are described in detail in international patent publications Nos. WO 2013/118116, WO 2013/179284, and WO 2015/022690 of the same inventor all incorporated herein by reference.

Although various features of the disclosure may be described in the context of a single embodiment, the features may also be provided separately or in any suitable combination. Conversely, although the disclosure may be described herein in the context of separate embodiments for clarity, the disclosure may also be implemented in a single embodiment. Furthermore, it should be understood that the disclosure can be carried out or practiced in various ways, and that the disclosure can be implemented in embodiments other than the exemplary ones described herein below. The descriptions, examples and materials presented in the description, as well as in the claims, should not be construed as limiting, but rather as illustrative.

The descriptions, examples and materials presented in the description, as well as in the claims, should not be construed as limiting, but rather as illustrative. Terms for indicating relative direction or location, such as “right” and “left”, “up” and “down”, “top” and “bottom”, “horizontal” and “vertical”, “higher” and “lower”, and the like, may also be used, without limitation.

In one main aspect, the present invention provides for an antenna configured and operable to simplify and improve the coupling process between a transmitting unit and a receiving unit of a wireless charging system which improves the efficiency level of the RF energy transfer between said transmitting and receiving units of a wireless charging system. Additionally, the antenna provided herein simplifies the design of wireless charging systems as the design of the complementary antenna is much simplified as its role in determining the electromagnetic field created is much diminished.

The term “antenna” as used herein, means a conductive material that converts radio frequency (RF) fields into alternating current or vice versa, upon which only one end of which is connected to a transmitting device or a receiving device.

The term “loop” as used herein, means two or more revolutions, each revolution adjacent to the previous revolution. Each revolution may be in the shape of a circle, oval, square, rectangle, or other geometric shape. Revolutions may extend vertically or helically, or horizontally or laterally. Each revolution may be in contact with the former revolution or spaced apart from the revolution providing an air gap between each revolution. The air gap may be uniform or non-uniform for each revolution, and the air gap may be filled by one or more non-conductive dielectric material known in the art.

The term “complimentary antenna” as used herein is directed to the antenna that couples with the open loop antenna of the invention. As the open loop antenna provided herein may be a transmitting antenna or a receiving antenna, the complimentary antenna can also be either one of a transmitting antenna or a receiving antenna in the wireless charging system of the invention.

The terms “coupling antenna”, “other antenna” and “second antenna” as used herein has the same meaning as the complementary antenna and is used interchangeably herein below. The complimentary antenna has a minimal role in affecting the shape, density, orientation and other parameters related to the electromagnetic/electric field that is being created by the main, dominant antenna in the wireless charging system, the open loop antenna, as will be described in detail herein below. As such, the complementary antenna may be a simple strip of a conductive material, a conductive wire, a conductive structural element (such as chassis) or a conductive functional element (such as induction coil) that are already incorporated in the device.

In accordance with embodiments of the invention the novel open loop antenna is composed of a conductive wire in a predefined length that is wrapped plurality of times to form repeatable loops to a certain length, and diameter or perimeter (depends on the shape of the loop), while yet maintaining an open loop structure having open ends. The loops may be made as a circular loop, oval loop, rectangular loop, spiral loop or any other geometrical structure known in the art. The open loop structure may be flat or three dimensional. In at least one embodiment, the antenna is configured to be attached to a receiving unit of a wireless charging system, or a transmitting unit of a wireless charging system.

The use of an open loop condensed antenna to solve unmet needs is a surprising result. In ordinary antennas theories and practice, in order to emit in a desired predefined frequency, the antenna dimensions should be in the same order of magnitude of the wavelength. This can result by using relatively large sized antennas. The unique open looped antenna provided herein, can resonate in the near filed region at a desired frequency, while maintaining small dimension of the antennas thank to the condensed looped structure, that is substantially smaller relative to the wavelength. In other words, the novel open looped antenna creates a near filed resonating structure that is smaller in an order of magnitude compared to the resonated wavelength.

The unique structure of the open loop antenna is capable to resonate in near field only and do not radiate to far field. Additionally, thanks to the unique structure of the condensed antenna, the intense electromagnetic field created around/within/on top of the antenna (according to the ground plane reference and the antenna parameters) can highly couple to any other antenna or conductive element and to resonate with it in the same frequency.

Embodiments include variations of the antenna and the ground plane and their position respective of each other in order to control the location of the charging zone.

In at least one embodiment, the antenna is mounted on or near a ground plane and oriented to distribute the electromagnetic near field in the inner volume of the antenna and the ground plane to create a charging zone interior to the volume created by the antenna for charging a rechargeable device (i.e. interior charging zone). The presence of the ground plane in this case causes the near field to distribute between the loop antenna and the ground plane, meaning that the field is being concentrated in the inner volume of the loop antenna.

In at least one embodiment, the antenna is mounted a distance away from the ground plane, or oriented relative to the ground plane, to distribute the electromagnetic near filed in the perimetric volume around the conductive material to create a charging zone on the perimeter of the conductive material revolutions for charging a rechargeable device (i.e. perimetric charging zone). In this case the presence of the ground plane has minimal or limited influence on the field distribution, meaning that the field is concentrated on the perimetric volume of the loop antenna. in this case, the antenna shape determines the field distribution.

In at least one embodiment, the antenna loops are formed laterally outward of the previous revolution to form a disc or plate shaped antenna (i.e. spiral antenna or any other planar structure) and mounted above a ground plane to distribute the electromagnetic near field in the volume above the conductive material to create a charging zone on the surface of the conductive material revolutions for charging a rechargeable device (i.e. cover charging zone). In this case the ground plane increases the field intensity in the other side of the flat antenna, meaning that high field intensity distribution covers the antenna.

In at least one embodiment, the frequency of the coupling between the receiving antenna and the transmitting antenna is determined according to the total length of the looped antenna. It is believed that the frequency of the wireless charging system may be controlled by changing the total length of the looped antenna, such that when the total length of the conductive wire increases, the frequency decrease and vice versa. For example, and without intending to limit the invention in any way, in one embodiment a novel antenna constructed using a looped wire with a total length of 180 cm and 1.5 mm diameter may determine/result a frequency of 27 MHz. For another example, in one embodiment a novel antenna constructed using a looped wire with a total length of 120 cm and 1.5 mm diameter may determine/result a frequency of 40 MHz. In some further embodiments of the invention, the thickness “T” of the conductive wire creating the looped antenna may also have a role in determining the frequency of the coupling between the transmitting and receiving antennas and on the charging process efficiency. The thickness of the conductive wire further affects the centralization/distribution of the field created.

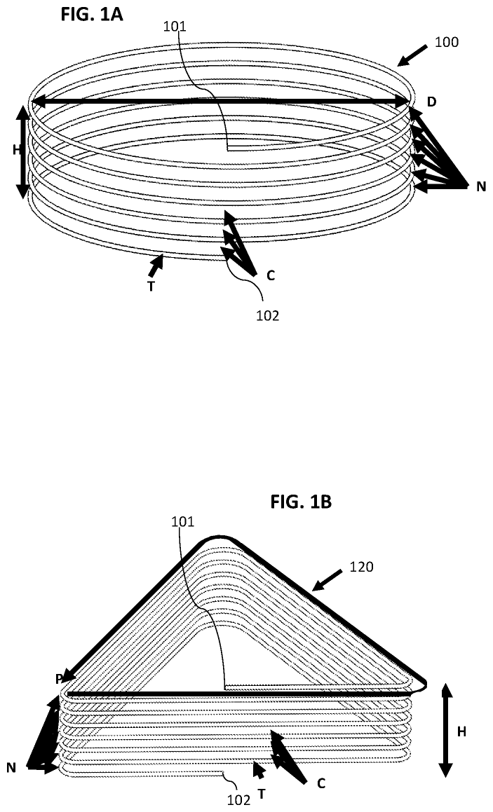

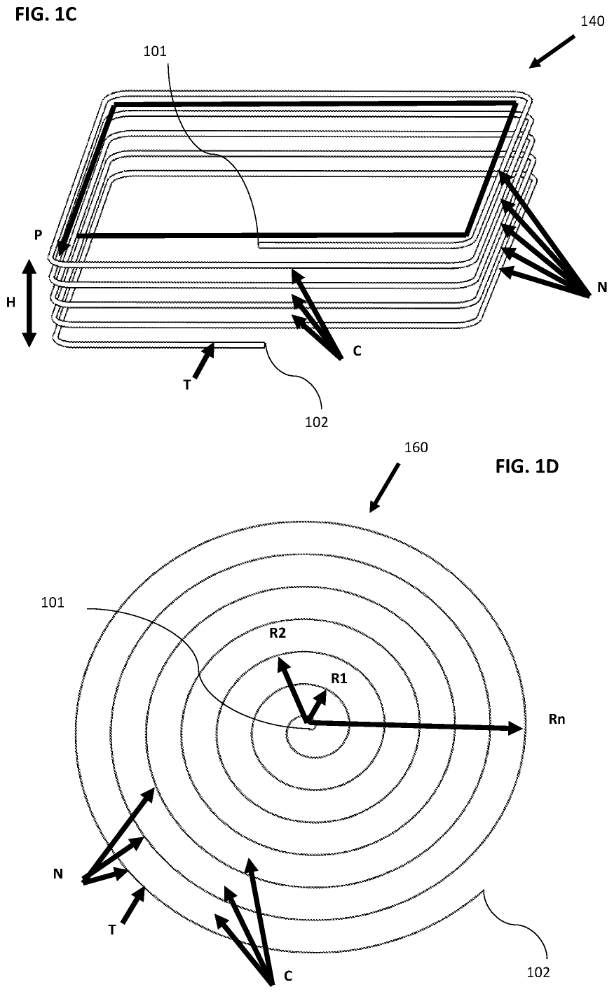

Other parameters that may also affect the created field, the charging frequency, the centralization/distribution of the created field, the distribution pattern of the field and the orientation are the number of the loops in the antenna “N”, i.e. the number of revolutions; the distance between each two loops “C”, i.e., the loop clearance; the loop diameter “D” when the loop has a circular shape; and the loop perimeter “P” when the loop has a none-circular shape such as triangular, rectangular, pentagon shape or else; the antenna height “H” when it has a 3D structure. Detailed description of the parameters effect on the creation of created field will be provided with reference to FIGS. 1A-1D and 2A-2C.

In contrast to the prior art wireless charging antennas, in which the structure of both, the transmitting and the receiving antenna, determines the frequency, the novel opened looped antenna provided herein is solely responsible on determining the frequency, in a manner that the shape and design of the other antenna that is coupled to it can vary without influencing the coupling between the two antennas, and the RF2RF transfer remains the same for different shapes and lengths of the “other” antenna. It should be clear that for simplifying the charging system comprising an open looped antenna, the other antenna can have a very simple structure such as but not limited to a flat metal/conductive wire or plate or strip in various lengths and width according to the available space and shape of the chargeable device or according to the charger available space and shape. Alternatively, the other antenna can be, for example a component in the charging device or in the DUC that may be used as an antenna in addition to its primary function.

The novel antenna is intended to be incorporated with a wireless charging system. Such wireless charging systems minimally include a transmitting unit, a receiving unit, and at least one novel antenna for attaching to either the transmitting unit or the receiving unit. In at least one embodiment, the antenna is configured to be attached to the transmitting unit. In at least one embodiment, the antenna is configured to be attached to the receiving unit.

Without being bound to any particular theory, the open looped antenna attached to either the transmitting unit or the receiving unit functionally determines the coupling frequency with the “other antenna” attached to the other unit, in a manner that functionally and operably the other antenna has no role in determining the frequency of the wireless charging system. The term “other antenna” as used herein is directed to a receiving antenna in a scenario that the open looped antenna is a transmitting antenna, and to a transmitting antenna in a scenario that the open looped antenna is a receiving antenna.

In at least one embodiment, the “other antenna” can also be shaped as an open looped antenna. In such scenario, the antenna that resonate in the lowest frequency will be the dominant antenna that will determine the frequency.

In at least one embodiment, the novel wireless charging open looped antenna may be implemented in various systems each designed to charge one or more of a variety of charging devices. Some none limiting examples are: drone, hear phones, hearing aids, IoT, medical devices, power tools, toys, clothing, shoes, cellular phones, charging cases, charging bags, charging backpacks, sport articles such as connected boxing gloves, connected glasses, connected football, charging boxes, charging hooks, charging cups, charging bowls, charging drawer, charging tool box, charging stand, charging ashtray, and actually in unlimited options of both—charging devices and devices to be charged.

In at least one embodiment, the open looped antenna comprises loops in a diameter that allows it to encircle an area while the device comprising the “other” antenna is positioned within this encircled area. In some other embodiments the loops diameter of the open looped antenna is much smaller, and the device with the “other” antenna is positioned either on top of it, below it or in front of it.

In at least one another embodiment of the invention, a novel receiving antenna may be made of a conductive strap in a geometric shape adaptive to the shape of a device under charge or parts thereof.

In at least one another embodiment of the invention, the novel receiving antenna may be made of conductive housing of a device under charge that is used in addition to its original functionality as a receiving antenna for wireless charging. Similarly, the receiving antenna may be made of conductive chassis of a device under charge that is used in addition to its original functionality as a receiving antenna for wireless charging.

In some further embodiments, the present invention teaches a method for converting any conductive particle of a device under charge to function as a receiving antenna for wireless charging upon connecting the conductive particle of the DUC to a rectifying unit.

Turning now to the figures:

FIGS. 1A-1D provide for schematic illustrations of various optional examples of the novel open loop antenna of the invention.

FIG. 1A illustrates at least one embodiment of the novel circle shaped open loop antenna 100 having a first opened end 101 and a second opened end 102 helically or vertically in relation to one another. Each loop antenna described herein, including the circle loop antenna 100, is defined by the diameter (D) of each loop or revolution, the perimeter (P) of each loop or revolution, the number (N) of loops or revolutions, the clearance distance (C) between each loop or revolution, the thickness (T) of each, and the height (H) created by the total number of revolutions (N) and clearance distance (C) between the first open end 101 and the second opened end 102 of the loop antenna. It should be appreciated where a loop antenna is a different geometric shape from a circle, that the diameter (D) of each loop revolution is adapted to the correct terminology relative to the shape. It should be appreciated that in this configuration, the charging zone may be configured to be internal to the circle shaped open loop antenna 100, or on its perimeter.

FIG. 1B illustrates at least one embodiment of the novel triangle shaped open loop antenna 120 having a first opened end 101 and a second opened end 102 helically or vertically in relation to one another. It should be appreciated that in this configuration, the charging zone may be configured to be internal to the triangle shaped open loop antenna 120, or on its perimeter.

FIG. 1C illustrates at least one embodiment of the novel rectangle shaped open loop antenna 140 having a first opened end 101 and a second opened end 102 helically or vertically in relation to one another. It should be appreciated that in this configuration, the charging zone may be configured to be internal to the rectangle shaped open loop antenna 140, or on its perimeter.

FIG. 1D illustrates at least one embodiment of the novel spiral shaped antenna 160 having a first opened end 101 and a second opened end 102 extending horizontally or laterally in relation to one another. In relation to this particular embodiment, or embodiments similar in configuration, R1, R2, Rn connotes each revolution having a different radius according to the distance from center, while the height (H) created by the total number of revolutions (N) and clearance distance (C) between the first open end 101 and the second opened end 102 of the loop antenna is zero, or near zero, as each revolution is on the horizontal or lateral plane. It is appreciated that this embodiment may be oriented in any way, and is not required to lay in any specific configuration (e.g. flat), and those skilled in the art may position in relation to the specific need and desired location of the charging zone created by the configuration. It should be appreciated that in this configuration, the charging zone is created on the surface (above) the plane of the spiral shaped antenna 160.

FIGS. 2A-2C are schematic exemplifying illustrations of the near field distribution created by the novel open loop antenna illustrated in FIG. 1A and FIG. 1D, showing the orientation of the field created upon referral of the antenna to a ground.

FIG. 2A illustrates one embodiment of the circular antenna 100 of FIG. 1A referred to a transmitter ground plane 104 in a vertical position oriented on the same plane as the circular antenna 100. At least one opened end 101, 102 is connected to an antenna port 106 for connecting the circular antenna 100 to the transmitter with ground plane 104. The configuration allows for the electromagnetic field lines 108, and hence the charging zone, to be internal to the antenna volume. It should be appreciated that similar embodiments may use different geometric shaped antenna, and nothing herein is intended to limit the antenna shape to a particular geometric shape. It should be appreciated that when the open loop antenna 100 is in close proximity to the ground plate 104, the electromagnetic field created is encompassed by the antenna 100. The field lines 108 are directed inward toward the ground plate 104.

FIG. 2B illustrates one embodiment of the circular antenna 100 of FIG. 1A referred to a transmitter ground plane 104 in horizontal position angle (α) relative to the circular antenna 100. Without being bound to a particular theory, it is believed that the angle (α) of the antenna axis in reference to the transmitter ground plate 104 affects the distribution pattern of the field created. The electromagnetic field for embodiments of this configuration (ground plane to antenna angle) is in a direction perpendicular to the antenna, thus the charging zone is exterior to the antenna.

FIG. 2C illustrates a pad configuration 240 showing the flat spiral antenna 160 of FIG. 1D referred to a ground plate 104 in horizontal position covering the surface or topside of the antenna 160. The electromagnetic field for embodiments of this configuration atop the transmitter ground plate 104 in, thus the charging zone is exterior and atop the transmitter ground plate 104 in opposite the side of the flat spiral antenna 160.

In summary, the concentrated shape of the antenna (with respect to the wavelength) of the antenna creates a non-radiative structure meaning that no radiation to far field is emitted. In contrast, there is a strong and focused near field generated in the given volume. The antenna structure is resonating in a given frequency that is not proportional to the dimensions of the structure. The repetitive structure of the antenna gives the antenna the ability to resonate in several frequencies. Based on this structure and field distribution behavior, a strong coupling can occur with receiving antennas that not resonating in the near field frequency, meaning that any type of conductor can function as a receiving antenna regardless to its size. The size of the receiving antenna is in order of magnitude smaller than the wavelength, that because of the strong coupling condition created by the transmitting antenna, it can be coupled and receive energy from the transmitting antenna in high efficiency. Meaning that the electromagnetic field frequency is determined only by the loop antenna regardless to the other antenna.

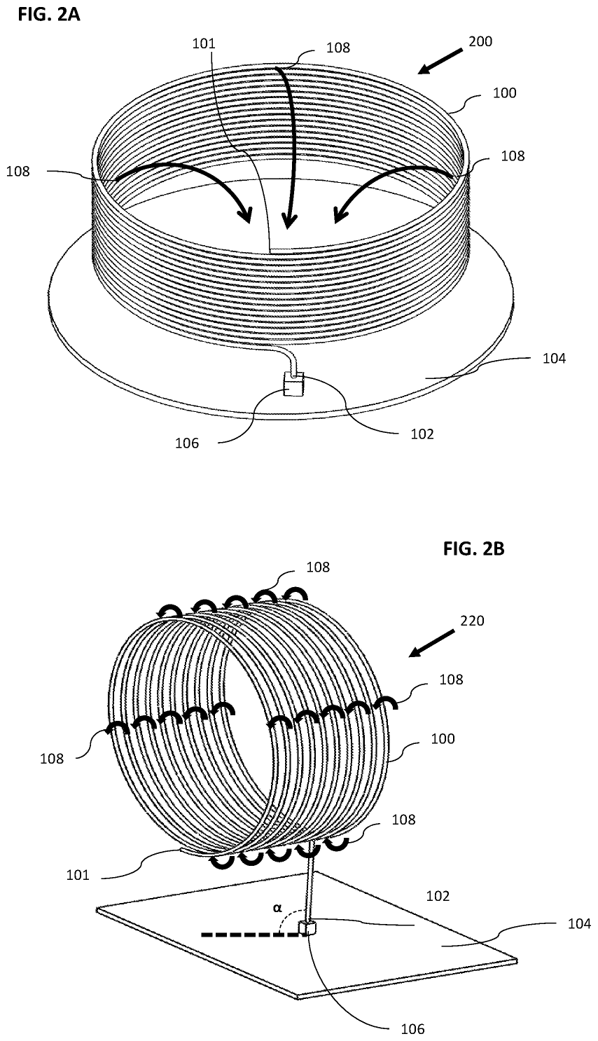

FIGS. 3A-3E illustrate at least some embodiments of a novel receiving antenna made.

FIG. 3A illustrates a receiving antenna 302 shaped as a curved conductive strap.

FIG. 3B illustrates a receiving antenna shaped as curved coiled wire 304. Some embodiments include the use of a inner core or supporting rod 148, preferably non-conductive, to allow for support and constraining the shape (loop diameter and clearance) of the coil wire antenna 304.

FIG. 3C illustrates a receiving antenna shaped as a conductive wire 306.

FIG. 3D illustrates a conductive housing 308 of a device under charge that is used in addition to its original functionality as a receiving antenna for wireless charging.

FIG. 3E illustrates an off-the-shelf inductive coil 310 that is being used in addition to its regular functionality as a receiving/transmitting antenna for the wireless charging system of the invention. It should be appreciated in this configuration, only one end of the inductive coil 310 is connected for receiving, such that the coil acts as an antenna and not an inductor. Certain embodiments may include a switch or other temporary connection to the second end of the inductor coil 310 thus providing a bi-functional antenna element.

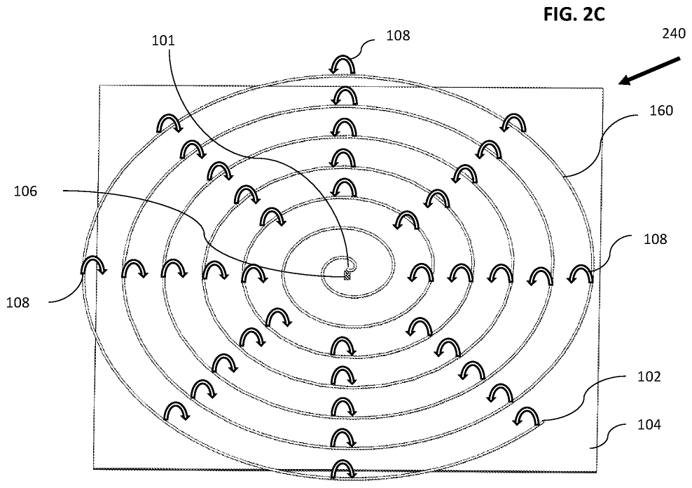

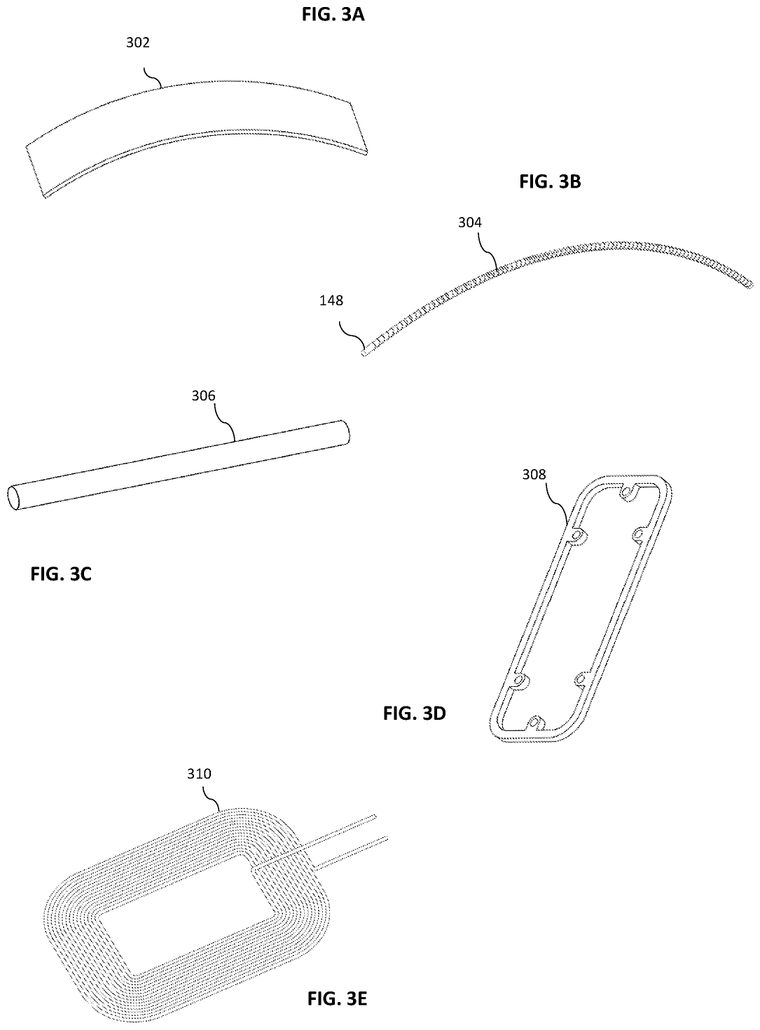

FIGS. 4A-4D are schematic illustrations of some optional wireless charging systems comprising open loop antennas as transmitting antennas coupling with different types of receiving antennas wherein, the open loop antenna is referred to the ground plane to create an inner electromagnetic field at the volume between the antenna and the ground plane.

FIG. 4A illustrates one embodiment of the wireless charging device 420 utilizing a conductive strip antenna 302, similar as to what is illustrated in FIG. 3A, and illustrating a device under charge 430, in this case a mobile phone, the mobile phone arranged in the 108 electromagnetic field lines for charging the device under charge.

FIG. 4B illustrates one embodiment of the wireless charging device 420 utilizing a coil antenna 304, similar as to what is illustrated in FIG. 3B, for a device under charge to be arranged in the electromagnetic field lines 108 for charging the device under charge.

FIG. 4C illustrates one embodiment of the wireless charging device 420 utilizing a chassis antenna 308, similar as to what is illustrated in FIG. 3D, and illustrating a device under charge 430, in this case a mobile phone, the mobile phone arranged in the electromagnetic field lines 108 for charging the device under charge.

FIG. 4D illustrates one embodiment of the wireless charging device 420 utilizing an inductive coil antenna 310, similar as to what is illustrated in FIG. 3E, and illustrating a device under charge 430, in this case a mobile phone, the mobile phone arranged in the electromagnetic field lines 108 for charging the device under charge.

FIGS. 4E-4F are illustrations of simulations results of the charging system illustrated in FIG. 4A. 100 is antenna, 419 is charging zone, DUC is 430, the antenna is that illustrated in FIG. 2A (circular antenna with ground plate). 429 is MEV (maximum energy volume), 302 is a conductive strip antenna connected to smart phone. 106 is ground plate.

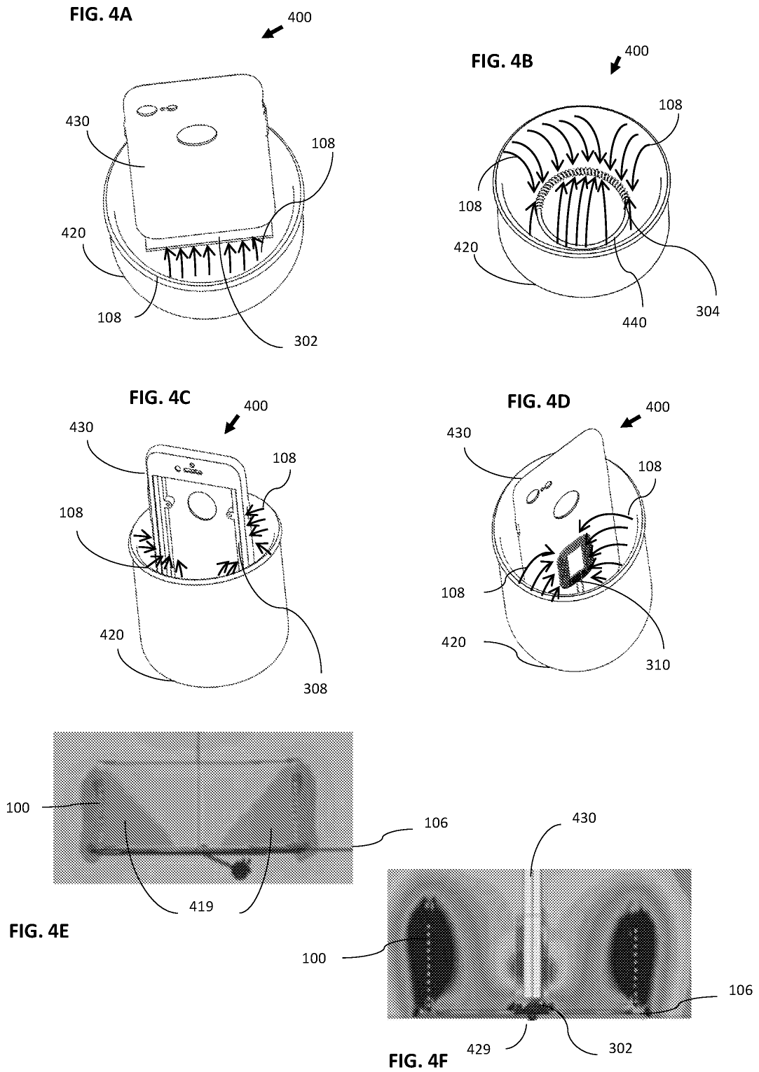

FIGS. 5A-5C are schematic illustrations of one optional wireless charging system comprising a charging device with open loop antenna referred to the ground plane to create electromagnetic field that around the loop antenna, suitable for a charging device designed for example, as a charging stand, and headphones (DUC) to be hanged on the charging stand for wireless charging.

FIG. 5A is a schematic illustration of the hook or platform charging system 500 designed as a stand 520, illustrating a device under charge 530 as a set of headphones, having an antenna configuration similar to what is described in FIG. 2B, and illustrating the field lines 108 and their direction in relation to the DUC to create a charging zone.

FIG. 5B is a schematic illustration of the devise under charge illustrating the conductive strip antenna 302 as illustrated in FIG. 3A, along with a rectifying unit 303.

FIG. 5C is a schematic illustration of the charging device with the transmitting unit and the square transmitting antenna 140 with a supporting plate 148. The configuration is similar to FIG. 2B and FIG. 1C. One end 101 or 102 of the antenna is connected to the transmitter with ground plate 104, while the other end 101 or 102 is left open, or not electrically connected, thus forming an antenna.

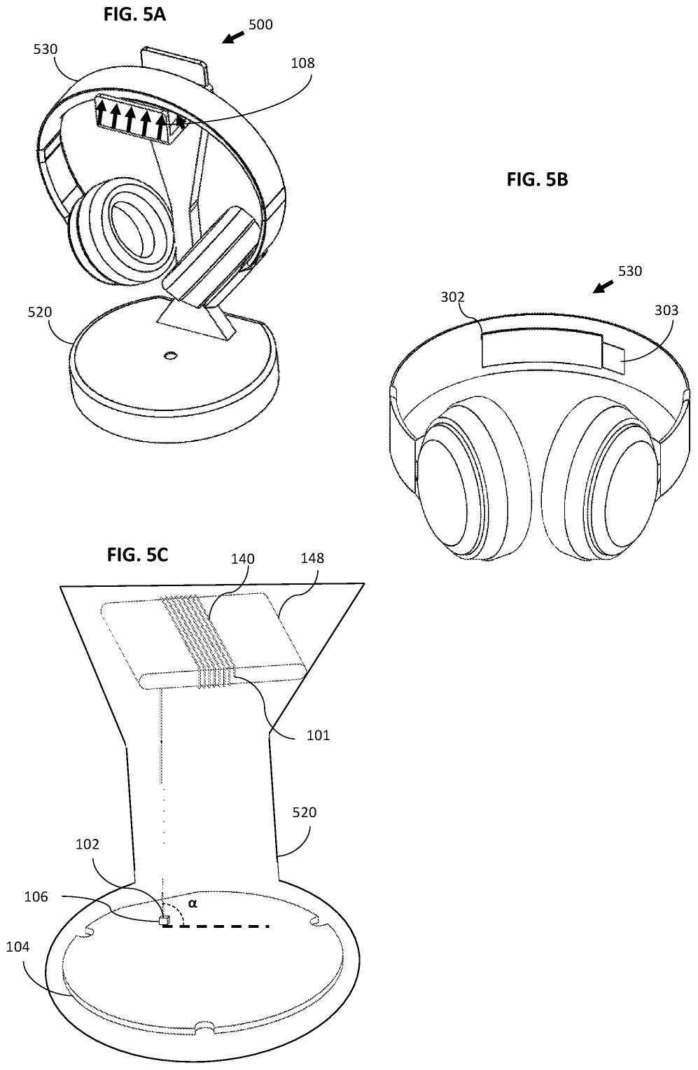

FIG. 6 is a schematic illustration of one another optional wireless charging system 600 according to the present invention, comprising a charging device with a flat spiral open loop antenna 620 referred to the ground plane 104 in a manner that the electromagnetic field 108 created on top of the looped antenna. Such distribution of the electromagnetic field allows a design of a charging device as a charging plate and to charge a wireless rechargeable drone 630 (DUC).

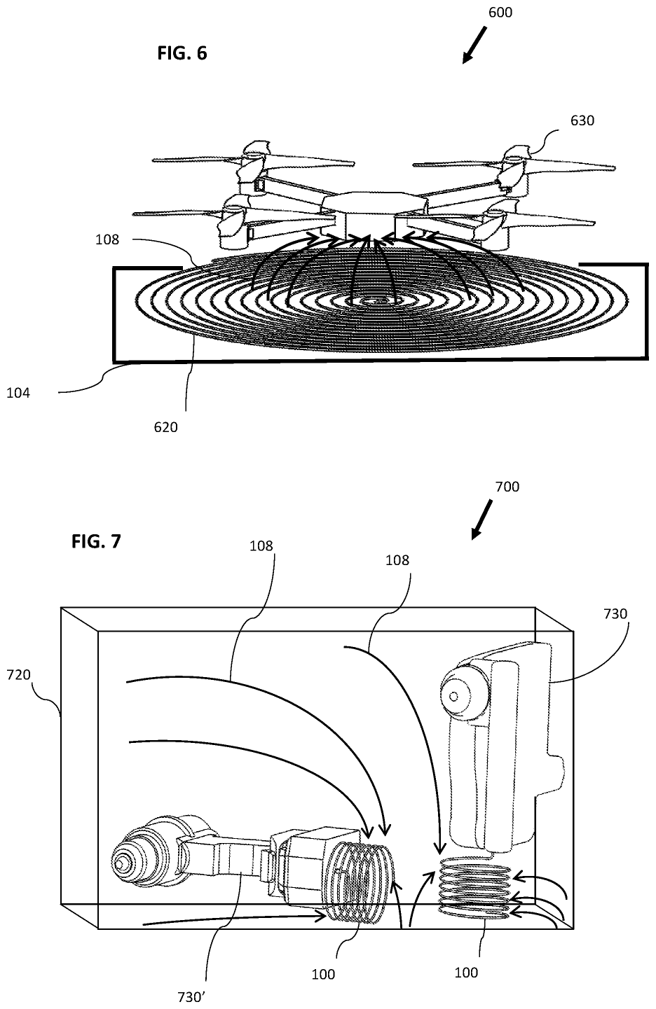

FIG. 7 is a schematic illustration of one another optional wireless charging system 700 according to the present invention, comprising a charging toolbox 720, wherein the chassis of the box function as a transmitting antenna and power tools 730, 730′ having open loop antennas 100 that function as a receiving antenna for wireless charging. The ground plane in this case is inside the toll connected to the receiving unit. The field created around each tool is perimeter field distributed around the loop antennas 100 therefore the field lines 108 from many directions from the toolbox are reaching them. Both tools resonate in the same frequency.

It should be clear that the description of the embodiments and attached Figures set forth in this specification serves only for a better understanding of the invention, without limiting its scope. It should also be clear that a person skilled in the art, after reading the present specification could make adjustments or amendments to the attached Figures and above described embodiments that would still be covered by the present invention.

In at least one embodiment, the present invention may be utilized to provide for a novel charging hook to act as a wireless charging device configured for individually or simultaneously charging various devices and/or their batteries by efficiently transferring electromagnetic near field into a charging zone. FIGS. 5A-5C provide a few possible embodiments utilizing the inventive antenna with a charging hook/stand configuration. In at least one embodiment of the invention, the novel charging hook/stand defined herein provides a device and method for creating a maximal energy volume (density) in a desired location inside a charging device (charging zone) created by the generating electromagnetic near field so as to provide charging of various devices and/or their batteries in the same universal charging device with maximal efficiency of the charging process.

The inventive charging hook/stand provides for wireless charging at least one electric device using electromagnetic near field. The charging hook/stand includes an outer housing defining an internal volume for holding a transmitting unit and at least one antenna. In one optional embodiment, the outer housing has a bottom and at least one side piece having a depth sufficient to defining an internal volume for holding a transmitting unit and at least one antenna and of sufficient strength to allow stable hanging of a device to be charged.

The inventive charging hook/stand preferably includes a top piece to be attached to the housing having at least one means for holding a DUC to be charged. Necessary for the wireless charging, the inventive charging hook further include at least one transmitting unit, and at least one antenna. A charging zone created substantially about or around the at least one means for holding a DUC to be charged so as to allow efficient charging of the DUC being hung on the charging hook.

Without being bound to a particular theory, it is believed that the concentrated shape (with respect to the wavelength) of the antenna creates a non-radiative structure, meaning that no near field to far field is emitted. In contrast, there is a strong and focused near field generated in the given volume defined by the antenna. The structure is resonant in a given frequency that is not proportional to the dimensions of the structure. That is, the condensed structure of the antenna allows for antenna dimensions differing by an order of magnitude comparing to the wavelength of the resonant frequency, while in an ordinary antenna optimal performance dimensions needs to be at the same order of magnitude as the wavelength of the resonant frequency. Accordingly, it is believed that the repetitive structure of the antenna gives the antenna the ability to resonate in several frequencies. Based on this structure and field distribution behavior, a strong coupling can occur with receiving antennas that does not resonate in the near field frequency, meaning that any type of conductor can function as a receiving antenna regardless to it size. The size of the receiving antenna is in order of magnitude smaller than the wavelength, but still, because of the strong coupling condition created by the transmitting antenna, it can be coupled and receive energy from the transmitting antenna in high efficiency. This means that the electromagnetic field frequency is determined only by the loop antenna regardless to the receiver antenna.

It should be appreciated that it is believed that another phenomena occurs in which the near field that generated by the loop antenna has no specific directivity, meaning that the field can coupled in any direction or angle between the X, Y, or Z axis. These phenomena occur because of the structure of the loop antenna and the near field distribution, the sensitivity to load changes caused by a different rechargeable device under charge (DUC) or number of DUC does not dramatically effects on the frequency and antenna impedance. Meaning that the stability of this antenna is very high.

In at least one embodiment, the antenna having one or more open loops is connected to the transmitting unit. In some embodiments of this configuration the loop antenna is sized to fit within the dimensions of the at least one side of the housing. To provide a non-limiting example, where the housing is circular, the open looped antenna may be an antenna that is looped to appear like an open coil sized to be the inner diameter of the housing. In some embodiments of this configuration, the receiving unit is adapted to have a simple antenna of conductive material connected to the receiving unit for charging the DUC.

In at least one embodiment, the antenna having one or more open loops is connected to the receiving unit. In such embodiments the antenna comprising one or more loops and the receiving unit are disposed of within the DUC. In some embodiments of this configuration, the transmitting unit is adapted to have a simple antenna of conductive material connected to the transmitting unit.

In some further embodiments, both the transmitting antenna and the receiving antenna may be designed as an open loop.

Embodiments of the present invention further provide for a novel charging cup holder to act as a wireless charging device configured for individually or simultaneously charging various electronic devices and/or their batteries by efficiently transferring electromagnetic near field from the charging cup holder into one or more DUC's or their batteries while being positioned in a charging zone. Without intending to limit the present invention, FIGS. 4A-4D provide a few embodiments of the present invention implemented in a cup holder configuration.

In at least one embodiment, the novel charging cup holder defined herein provides a device and method for creating a maximal energy volume (density) in a desired location inside a charging device (charging zone) created by the generating electromagnetic near field so as to provide charging of various devices and/or their batteries in the same universal charging device with maximal efficiency of the charging process.

In at least one embodiment, the inventive charging cup holder provides for wireless charging at least one electric device using electromagnetic near filed. The charging cup holder includes a housing having a bottom piece, a top piece, at least one outer side piece and at least one inner side piece, said side pieces having a depth sufficient to form an internal volume within said housing an outer housing having a closeable lid containing a substantially hollow inner internal volume for holding a transmitting unit and at least one antenna. The arrangement of the outer and inner side pieces is to make the housing to have a “structure within a structure” so as to create an internal volume for housing the components of the invention, while further providing a volume that may function to hold DUC's, or when not being used as a charger other items such as cups or food. By way of non-limiting example, in embodiments where the housing is round, the construction of the inner housing relative to the outer housing forms a donut like housing. In embodiments of the inventive cup holder, the housing has a depth sufficient to form an internal volume within the inner and outer housings, as well as an internal volume within the inner housing. It should be appreciated that the internal volume formed within the inner housing forms a holding area suitable for holding small portable electronics, or for holding other items, such as a cup, when not in use as a wireless charger.

In some embodiments the housing may be circular, thus having only one side piece of circular dimension about the diameter of the bottom piece. In some embodiments the housing may be in the shape of one of many polygons, thus having a plurality of side pieces to form the housing, which along with the bottom piece, defines an inner internal volume. In some embodiments, the outer housing and the inner housing may have different geometrical shapes. By way of non-limiting example, the outer housing may be square, with a round inner housing.

In at least one embodiment, the antenna having one or more open loops is connected to the transmitting unit. In such embodiments, the antenna and the transmitting unit are disposed of in the inner internal volume formed between the outer housing and the inner housing of the charging cup holder. In some embodiments of this configuration the open loop antenna is sized to fit within the dimensions of the at least one side of the housing. To provide a non-limiting example, where the housing is circular, the open loop antenna may be an antenna that is looped to appear like an open coil sized to be the inner diameter of the housing. FIG. 4B provides an illustration of at least one embodiment of such configuration. In some embodiments of this configuration, the receiving unit is adapted to have a simple antenna of conductive material connected to the receiving unit for charging the DUC. The receiving unit is placed within the cup holder, and thus providing a charge.

In at least one embodiment, the antenna having one or more open loops is connected to the receiving unit. In such embodiments the antenna comprising one or more open loops and the receiving unit are disposed of within the DUC. In some embodiments of this configuration, the transmitting unit is adapted to have a simple antenna of conductive material connected to the transmitting unit, and the simple conductive antenna and the transmitting unit are disposed of within the inner internal volume of the charging cup holder.

In some further embodiments, both the transmitting antenna and the receiving antenna may be designed as an open loop.

Some embodiments of inventive antenna may be utilized with one or more novel charging toolbox to act as a wireless charging device configured for individually or simultaneously charging various portable tool and/or their batteries by efficiently transferring electromagnetic near field from the charging tool box into these portable tools or their batteries, while all being positioned within a charging zone. FIG. 7 provides for at least one exemplary charging toolbox.

In at least one embodiment of the invention, the novel charging toolbox defined herein provides a device and method for creating a maximal energy volume (density) in a desired location inside a charging device (charging zone) created by the generating electromagnetic near field so as to provide charging of various devices and/or their batteries in the same universal charging device with maximal efficiency of the charging process.

The inventive charging toolbox provides for wireless charging at least one electric device using electromagnetic near field. The charging toolbox includes an outer housing having a closeable lid containing a substantially hollow inner internal volume for holding a transmitting unit and at least one antenna. The outer housing has a bottom and at least one side piece having a depth sufficient to form an internal volume within the housing.

In some embodiments the housing may be circular, thus having only one side piece of circular dimension about the diameter of the bottom piece. In some embodiments the housing may be in the shape of one of many polygons, thus having a plurality of side pieces to form the housing, which along with the bottom piece, defines an inner internal volume.

The inventive charging toolbox further includes a lid attached to the housing and capable of being opened to allow the routine placement or removal of at least one portable tool or battery therefor to be charged. Necessary for the wireless charging, the inventive charging toolbox further include at least one transmitting unit, at least one antenna, and a charging zone created substantially about or around all or a portion of the internal volume created by the housing for holding at least one portable tool or battery therefor to be charged.

In at least one embodiment, the antenna having one or more open loops is connected to the transmitting unit. In such embodiments, the antenna and the transmitting unit are disposed of within the inner internal volume of the charging toolbox. In some embodiments of this configuration the open loop antenna is sized to fit within the dimensions of the at least one side of the housing. To provide a non-limiting example, where the housing is circular, the open loop antenna may be an antenna that is looped to appear like a coil sized to be the inner diameter of the housing. In some embodiments of this configuration, the receiving unit is adapted to have a simple antenna of conductive material connected to the receiving unit for charging the at least one portable tool or battery therefor. The at least one portable tool or battery therefor positioned within the toolbox and being wirelessly charged as a result of the charging zone being created at the receiving unit due to the transmission of electromagnetic near field from the transmitting unit.

In at least one embodiment, the antenna having one or more open loops is connected to the transmitting unit and each is disposed of in the lid.

In at least one embodiment, the antenna having one or more open loops is connected to the receiving unit. In such embodiments the antenna comprising one or more open loops and the receiving unit are disposed of within the at least one portable tool or battery therefor. In some embodiments of this configuration, the transmitting unit is adapted to have a simple antenna of conductive material connected to the transmitting unit, and the simple conductive antenna and the transmitting unit are disposed of within the inner internal volume of the charging toolbox.

In some further embodiments, both the transmitting antenna and the receiving antenna may be designed as an open loop.

In one another optional embodiment, the charging toolbox may comprise two or more open loop transmitting antennas one positioned, for example one at the bottom piece of the charging toolbox while the other is positioned on the lid. In such scenario, each one of the chargeable tools may comprise a receiving antenna made of a conductive material that is shaped for example as a flat strip, a wire, a plate, or as an open looped antenna structure shorter than the open looped antenna of the transmitting unit.

As described previously, the inventive charging toolbox is intended to be adapted to hold a variety of devices either individually or simultaneously. Thus, a plurality of sizes for the inventive toolbox is possible. The parameters of the housing and antenna construction of the charging toolbox defining the parameters of the internal volume (width, height, diameter, etc.) are selected in accordance with the frequency band intended to be used, and further the frequency of the near field might be tuned to further adjust the volume of the substantially maximal intensity of near field to at least partially overlap with the charging zone.

Some embodiments of the present invention provide for a novel headphone charging case to act as a wireless charging device configured for individually or simultaneously charging one or more sets of headphones and/or their batteries by efficiently resonating electromagnetic near field from the headphone charging case into one or more headphones or their batteries while being positioned in a charging zone. In at least one embodiment, the novel headphone charging case defined herein provides a device and method for creating a maximal energy volume (density) in a desired location inside a charging device (charging zone) created by the resonating electromagnetic near field so as to provide charging of one or more sets of headphones and/or their batteries in the same universal charging device with maximal efficiency of the charging process.

In such embodiments, the inventive headphone charging case provides for wireless charging at least one pair of headphones using electromagnetic near field. The headphone charging case includes a housing having a bottom piece, a top piece, at least one outer side piece and at least one inner side piece, said side pieces having a depth sufficient to form an internal volume within said housing an outer housing having a closeable lid containing a substantially hollow inner internal volume for holding a transmitting unit and at least one antenna. The arrangement of the outer and inner side pieces is to make the housing to have a “structure within a structure” so as to create an internal volume for housing the components of the invention, while further providing a volume that may function to hold one or more headphones. By way of non-limiting example, in embodiments where the housing is round, the construction of the inner housing relative to the outer housing forms a donut like housing. In embodiments of the inventive cup holder, the housing has a depth sufficient to form an internal volume within the inner and outer housing, as well as an internal volume within the inner housing. It should be appreciated that the internal volume formed within the inner housing forms a holding area suitable for holding one or more headphones.

In some embodiments the housing may be circular, thus having only one side piece of circular dimension about the diameter of the bottom piece. In some embodiments the housing may be in the shape of one of many polygons, thus having a plurality of side pieces to form the housing, which along with the bottom piece, defines an inner internal volume. In some embodiments, the outer housing and the inner housing may have different geometrical shapes. By way of non-limiting example, the outer housing may be square, with a round inner housing.

The antenna is operable to resonate the electromagnetic near field to provide a maximal intensity of electromagnetic near field within at least a part of said charging zone. To improve the coupling process between a transmitting unit and a receiving unit of a wireless charging system which improves the efficiency level of the RF energy transfer between said transmitting and receiving units of a wireless charging system, in at least one embodiment the antenna is one having one or more open loops having a geometric shape.

In at least one embodiment, the antenna having one or more open loops is connected to the transmitting unit. In some embodiments of this configuration the loop antenna is sized to fit within the dimensions of the at least one side of the housing. To provide a non-limiting example, where the housing is circular, the open looped antenna may be an antenna that is looped to appear like an open coil sized to be the inner diameter of the housing. In some embodiments of this configuration, the receiving unit is adapted to have a simple antenna of conductive material connected to the receiving unit for charging the headphone.

In at least one embodiment, the antenna having one or more open loops is connected to the receiving unit. In such embodiments the antenna comprising one or more loops and the receiving unit are disposed of within the headphone. In some embodiments of this configuration, the transmitting unit is adapted to have a simple antenna of conductive material connected to the transmitting unit, and the simple conductive antenna and the transmitting unit are disposed of within the inner cavity of the headphone charging case.

In some further embodiments, both the transmitting antenna and the receiving antenna may be designed as an open loop.

In one another optional embodiment, the headphone charging case may comprise two or more open loop transmitting antennas one positioned, for example one at the bottom piece of the headphone charging case while the other is positioned on the lid. In such scenario, each one of the chargeable headphones may comprise a receiving antenna made of a conductive material that is shaped for example as a flat strip, a wire, a plate, or as an open looped antenna structure shorter than the open looped antenna of the transmitting unit.

As described previously, the inventive headphone charging case is intended to be adapted to hold a variety of headphones either individually or simultaneously. Thus, a plurality of sizes for the inventive headphone charging case is possible. The parameters of the housing and antenna construction of the headphone charging case defining the parameters of the internal volume (width, height, diameter, etc.) are selected in accordance with the frequency band intended to be used, and further the frequency of the near field might be tuned to further adjust the volume of the substantially maximal intensity of near field to at least partially overlap with the charging zone.

Some embodiments of the present invention may be used to provide for a novel mobile device charging case to act as a wireless charging device configured for individually or simultaneously charging one or more sets of mobile devices and/or their batteries by efficiently transferring electromagnetic near field from the mobile device charging case into one or more mobile devices or their batteries while being positioned in a charging zone. In at least one embodiment, the novel mobile device charging case defined herein provides a device and method for creating a maximal energy volume (density) in a desired location inside a charging device (charging zone) created by the transmitted electromagnetic waves so as to provide charging of one or more sets of mobile devices and/or their batteries in the same universal charging device with maximal efficiency of the charging process.

Necessary for the wireless charging, the inventive mobile device charging case further includes at least one transmitting unit, and at least one transmitting antenna and a charging zone created substantially about or around the at volume for holding a mobile device to be charged so as to allow efficient charging of the mobile device being placed in the mobile device charging case.

In at least one embodiment, the antenna having one or more open loops is connected to the transmitting unit. In some embodiments of this configuration the loop antenna is sized to fit within the dimensions of the at least one side of the housing. To provide a non-limiting example, where the housing is circular, the open looped antenna may be an antenna that is looped to appear like an open coil sized to be the inner diameter of the housing. In some embodiments of this configuration, the receiving unit is adapted to have a simple antenna of conductive material connected to the receiving unit for charging the mobile device.

In at least one embodiment, the antenna having one or more open loops is connected to the receiving unit. In such embodiments the antenna comprising one or more loops and the receiving unit are disposed of within the mobile device. In some embodiments of this configuration, the transmitting unit is adapted to have a simple antenna of conductive material connected to the transmitting unit, and the simple conductive antenna and the transmitting unit are disposed of within the inner cavity of the mobile device charging case.

In some further embodiments, both the transmitting antenna and the receiving antenna may be designed as an open loop.

In one another optional embodiment, the mobile device charging case may comprise two or more open loop transmitting antennas one positioned, for example one at the bottom piece of the mobile device charging case while the other is positioned on the lid. In such scenario, each one of the chargeable mobile devices may comprise a receiving antenna made of a conductive material that is shaped for example as a flat strip, a wire, a plate, or as an open looped antenna structure shorter than the open looped antenna of the transmitting unit.

As described previously, the inventive mobile device charging case is intended to be adapted to hold a variety of mobile devices either individually or simultaneously. Thus, a plurality of sizes for the inventive mobile device charging case is possible. The parameters of the housing and antenna construction of the mobile device charging case defining the parameters of the internal volume (width, height, diameter, etc.) are selected in accordance with the frequency band intended to be used, and further the frequency of the near field might be tuned to further adjust the volume of the substantially maximal intensity of near field to at least partially overlap with the charging zone.

Other embodiments of a mobile device charging case enable a mobile device to be able to receive a wireless charge without requiring the mobile device to be taken apart. Such embodiments include a case body configured to be secured around a mobile device, wherein the case body includes a front piece and a back piece configured to releasably attach to each other to enclose a mobile device. Internal to the case is at least one antenna. In some embodiments, the antenna is configured and operable to improve the coupling process with a receiving antenna of a wireless chargeable device, so as to improves the efficiency level of the RF energy transfer between said transmitting antenna and a receiving antenna, the transmitting antenna comprising one or more open loops having a geometric shape.

Embodiments of the present invention provide for a novel drone charging system to act as a wireless charging device configured for individually or simultaneously charging drone devices and/or their batteries by efficiently transferring electromagnetic near field from the drone charging system into one or more drones or their batteries while being positioned in a charging zone. FIG. 6 illustrates at least one embodiment.

In at least one embodiment of the invention, the novel drone charging system defined herein provides a device and method for creating a maximal energy volume (density) in a desired location inside a charging device (charging zone) created by the resonating electromagnetic near field so as to provide charging of various drones and/or their batteries in the same universal charging device with maximal efficiency of the charging process.

The inventive drone charging system preferably includes a top piece to act as a pad or docking station for a drone device. Necessary for the wireless charging, the inventive drone charging system further includes at least one transmitting unit, and at least one antenna. A charging zone created substantially about or around the pad or docking station for a drone device so as to allow efficient charging of the drone device interfacing with the charging system.

The antenna is operable to resonate the electromagnetic near field to provide a maximal intensity of electromagnetic near field within at least a part of said charging zone. To improve the coupling process between a transmitting unit and a receiving unit of a wireless charging system which improves the efficiency level of the RF energy transfer between said transmitting and receiving units of a wireless charging system, in at least one embodiment the antenna is one having one or more open loops having a geometric shape.

In at least one embodiment, the antenna having one or more open loops is connected to the transmitting unit. In some embodiments of this configuration the loop antenna is sized to fit within the dimensions of the at least one side of the housing. To provide a non-limiting example, where the housing is circular, the open looped antenna may be an antenna that is looped to appear like an open coil sized to be the inner diameter of the housing. In some embodiments of this configuration, the receiving unit is adapted to have a simple antenna of conductive material connected to the receiving unit for charging the drone device. The drone device is directed to land or park on the pad or docking station and is wirelessly charged as a result of the charging zone being created at the pad or docking station due to the transmission of electromagnetic near field from the transmitting unit. In some embodiments, the simple conductive antenna may be attached to an outer or inner surface of the drone or be adapted be all or a portion of the legs of the drone.

In at least one embodiment, the antenna having one or more open loops is connected to the receiving unit. In such embodiments the antenna having one or more open loops and the receiving unit are disposed of within the drone device. In some embodiments of this configuration, the transmitting unit is adapted to have a simple antenna of conductive material connected to the transmitting unit, and the simple conductive antenna and the transmitting unit are disposed of within the inner cavity of the drone charging system. In some embodiments, the open loop antenna may be attached to an outer or inner surface of the drone or be adapted be all or a portion of the legs of the drone.

In some further embodiments, both the transmitting antenna and the receiving antenna may be designed as an open loop.

As described previously herein, the inventive drone charging system is intended to be able to be adapted to charge one or more drone devices, as well as a variety of different makes and manufacturers of drones. The parameters of the housing and antenna construction of the drone charging system defining the charging zone (width, height, diameter, etc.) are selected in accordance with the frequency band intended to be used, and further the frequency of the near field might be tuned to further adjust the volume of the substantially maximal intensity of near field to partially or totally overlap with the charging zone.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the described embodiments in any way. Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

1. An antenna configured and operable to create strong electromagnetic near fields in a designated volume and by that to improve the coupling between a transmitting antenna and a receiving antenna of a wireless charging system, which improves the efficiency level of the electromagnetic energy transfer between said transmitting and receiving antennas of a wireless charging system, the antenna comprising a conductive material shaped to form two or more revolutions, each revolution adjacent to the previous revolution, wherein each of said revolution having a geometric shape.

2. The antenna of claim 1, further comprising a ground plane, wherein said formed conductive material is adapted to confine the electromagnetic near field distribution into a charging zone relative to the ground plane.

3. The antenna of claim 1, wherein the conductive material is configured such that the strong electromagnetic near field distribution covers any direction and orientation inside the designated volume for the resonated frequencies.

4. The antenna of claim 1, wherein the resonant frequency of the electromagnetic energy transfer between said transmitting and receiving antennas of a wireless charging system may be adjusted by altering the number of revolutions of the conductive material, altering the size of the revolution, altering the distance between revolutions, altering the thickness of the conductive material, and combinations thereof.

5. The antenna of claim 1, wherein the charging aperture is determined by the geometrical shape of the conductive material and the relative position and/or orientation of the conductive material to the ground plane.

6. The antenna of claim 1, wherein the revolutions of the conductive material are mounted on or near a ground plane and oriented to distribute the electromagnetic near field in the inner volume of the two or more conductive material revolutions and the ground plane to create a charging zone interior to the conductive material revolutions for charging a rechargeable device.

7. The antenna of claim 1, wherein the revolutions of the conductive material are mounted in a distance away from the ground plane, or oriented relative to the ground plane, to distribute the electromagnetic near filed in the perimetric volume around the conductive material to create a charging zone on the perimeter of the conductive material revolutions for charging a rechargeable device.

8. The antenna of claim 1, wherein each revolution of conductive material is outward of the previous revolution to form a flat conductive material revolutions and mounted above a ground plane to distribute the electromagnetic near field in the volume above the conductive material to create a charging zone on the surface of the conductive material revolutions for charging a rechargeable device.

9. The antenna of claim 1, wherein the dimensions of each revolution and the dimensions of the structure of conductive material are significantly smaller than the resonated frequency wavelength.

10. The antenna of claim 1, wherein the revolutions of conductive material can be formed to make any repeatable shape, any helical height or any perimeter.

11. The antenna of claim 1, wherein the revolutions of conductive material may be configured to be attached to a transmitting unit of a wireless charging system or to a receiving unit of a wireless charging system.

12. A wireless charging system comprising:
a transmitting unit;
a receiving unit; and
at least one antenna of claim 1.

13. The system of claim 12, wherein said at least one antenna attached to said transmitting unit is different from said at least one antenna attached to said receiving unit, wherein the antennas are different structure or geometric shape.

14. The system of claim 12, wherein said at least one antenna attached to said transmitting unit is an open loop antenna and at least one antenna is attached to said receiving unit is an open loop antenna having a different length, wherein the antenna that resonate in a lower frequency is the dominant antenna that determines the frequency.

15. The system of claim 12, further comprising a second antenna (Rx) wherein the second antenna is significantly smaller then wavelength of the frequency resonated by the first antenna, wherein the near field generated by said first antenna resonates said second antenna in certain frequency thereby causing a strong coupling between the antennas.

16. The system of claim 15 wherein the second antenna is made of any conductive material and can be in any shape and size regardless to the resonant frequency.

17. The system of claim 15 wherein the second antenna is an off-the-shelf inductive charging coil.

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. An antenna for wireless charging configured and operable to create strong electromagnetic near fields in a designated volume, said antenna is characterized by having a conductive material shaped to form two or more cyclic revolutions (loops) each revolution having a the same geometrical shape as the revolution adjacent to it, wherein said strong electromagnetic near field created resonates another antenna to be coupled thereto as a receiving antenna, to thereby improve the efficiency level of the electromagnetic energy transfer between the two antennas, and wherein the resonant frequency of the electromagnetic energy transfer between the two antennas of a wireless charging system may be adjusted by altering the number of revolutions of the conductive material, altering the perimeter of the revolution, altering the distance between two adjacent revolutions, altering the thickness of the conductive material, altering the total height of the antennas, and combinations thereof.

31. The antenna of claim 31 wherein said two or more cyclic revolutions are arranged in three-dimensional (3D) or two-dimensional (2D) structure.
